(19) United States
(12) Patent Application Publication
(10) Pub. No.: US 2011/0246913 A1
(43) Pub. Date: Oct. 6, 2011

(54) Automated User Interface Generator

(75) Inventors: Neil LYDICK, Seattle, WA (US); Amit KAMAT, Sammamish, WA (US); Gaurav KAPILA, Redmond, WA (US); Bhavna CHAUHAN, Redmond, WA (US); Bahadir ONALAN, Bellevue, WA (US); Jagadeesh KALKI, Redmond, WA (US); Mark STERIN, Redmond, WA (US); Corina FEUERSTEIN, Redmond, WA (US); Makenzie SNOW, Fall City, WA (US); Rekha NAIR, Kirkland, WA (US)

(73) Assignee: MICROSOFT CORPORATION, Redmond, WA (US)

(21) Appl. No.: 12/749,568

(22) Filed: Mar. 30, 2010

(51) Int. Cl. G06F 3/048

(52) U.S. Cl. 715/762

(57) ABSTRACT

A user interface may be selected for a system with hierarchical data types by traversing an inheritance tree to find a pre-defined user interface, or by automatically generating a user interface based on the type definition. The automatically generated user interface may include tabs or groupings for components of the data type that may be inherited from other data types. In some embodiments, portions of the automatically generated user interface may be obtained from other data types.

### BACKGROUND

Large scale applications, such as computer monitoring systems, may have many different data types. The data types may be complex data types that may be created for displaying instances of the data types, as well as soliciting information from a user. In some such applications, there may be many hundreds of data types, each of which may have a different user interface.

### SUMMARY

A user interface may be selected for a system with hierarchical data types by traversing an inheritance tree to find a pre-defined user interface, or by automatically generating a user interface based on the type definition. The automatically generated user interface may include tabs or groupings for components of the data type that may be inherited from other data types. In some embodiments, portions of the automatically generated user interface may be obtained from other data types.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

In the drawings,

FIG. 1 is a diagram illustration of an embodiment showing a system with an automated user interface generator.

FIG. 2 is a flowchart illustration of an embodiment showing a method for creating a user interface.

FIG. 3 is a flowchart illustration of an embodiment showing a method for presenting a populated user interface.

FIG. 4 is a diagram illustration of an embodiment showing an example of hierarchical data types.

FIG. 5 is a diagram illustration of an embodiment showing an example of a first user interface.

FIG. 6 is a diagram illustration of an embodiment showing an example of a second user interface.

### DETAILED DESCRIPTION

A user interface may be created based on a hierarchical data type definition for an item. The hierarchical data type definition may include properties that may be inherited between different items, and as well as various annotations that may be used to create a user interface. The annotations may include descriptors, default values, and other information.

A user interface may be created by attempting to find a predefined user interface that may be associated with a selected data type. If a user interface exists for the data type, that user interface may be used. If no user interface is defined for the data type, the hierarchical data type definition may be traversed to find a predefined user interface for another data type. The differences between the two data types may be identified and a user interface may be built from the predefined user interface along with an automated user interface for those differences.

The automated user interface generator may be useful for applications where many different data types exist or where a user may be able to extend a data type. Rather than creating custom user interfaces for each data type, several predefined user interfaces may be created and the automated user interface generator may customize the predefined user interface to adapt to each specific data type. With a user-extendable data type, the user-added elements may be added to an existing user interface automatically.

Throughout this specification, like reference numbers signify the same elements throughout the description of the figures.

When elements are referred to as being “connected” or “coupled,” the elements can be directly connected or coupled together or one or more intervening elements may also be present. In contrast, when elements are referred to as being “directly connected” or “directly coupled,” there are no intervening elements present.

The subject matter may be embodied as devices, systems, methods, and/or computer program products. Accordingly, some or all of the subject matter may be embodied in hardware and/or in software (including firmware, resident software, micro-code, state machines, gate arrays, etc.) Furthermore, the subject matter may take the form of a computer program product on a computer-usable or computer-readable storage medium having computer-usable or computer-readable program code embodied in the medium for use by or in connection with an instruction execution system. In the context of this document, a computer-usable or computer-readable medium may be any medium that can contain, store, communicate, propagate, or transport the program for use by or in connection with the instruction execution system, apparatus, or device.

The computer-usable or computer-readable medium may be for example, but not limited to, an electronic, magnetic, optical, electromagnetic, infrared, or semiconductor system, apparatus, device, or propagation medium. By way of example, and not limitation, computer-readable media may comprise computer storage media and communication media.

Computer storage media includes volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and may be accessed by an instruction execution system. Note that the computer-usable or computer-readable medium can be paper or other suitable medium upon which the program is printed, as the program can be electronically captured via, for instance, optical scanning of the paper or other suitable medium, then compiled, interpreted, of otherwise processed in a suitable manner, if necessary, and then stored in a computer memory.

Communication media typically embodies computer-readable instructions, data structures, program modules or other data in a modulated data signal such as a carrier wave or other transport mechanism and includes any information delivery media. The term “modulated data signal” can be defined as a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above-mentioned should also be included within the scope of computer-readable media.

When the subject matter is embodied in the general context of computer-executable instructions, the embodiment may comprise program modules, executed by one or more systems, computers, or other devices. Generally, program modules include routines, programs, objects, components, data structures, and the like, that perform particular tasks or implement particular abstract data types. Typically, the functionality of the program modules may be combined or distributed as desired in various embodiments.

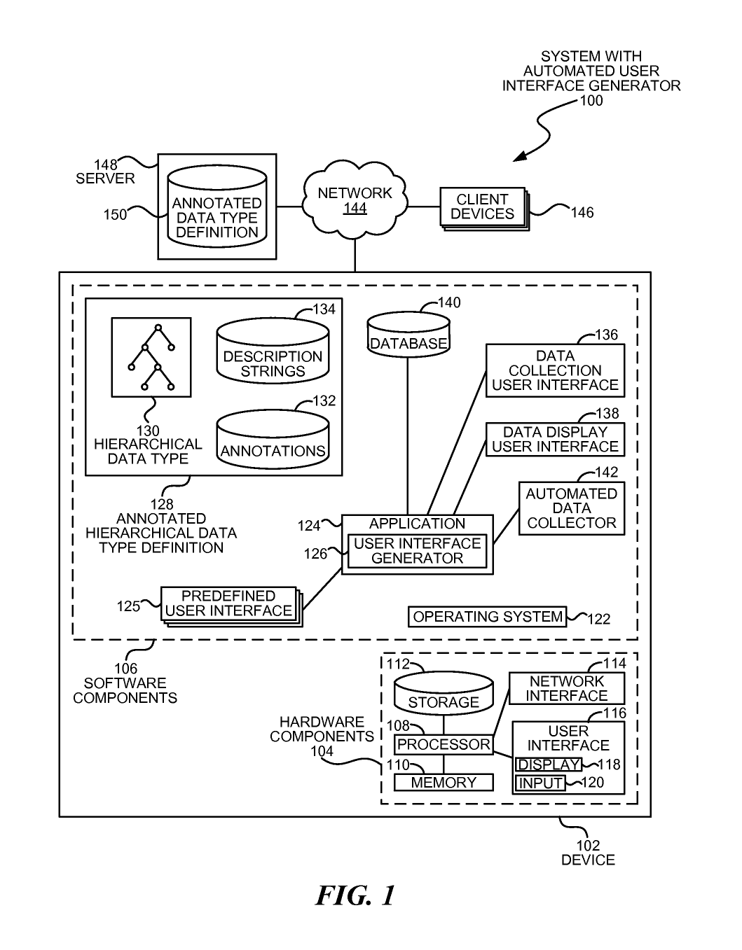

FIG. 1 is a diagram of an embodiment 100, showing a system with an automated user interface generator. Embodiment 100 is a simplified example of a system that may have an application which may automatically generate a user interface based on a hierarchical type definition.

The diagram of FIG. 1 illustrates functional components of a system. In some cases, the component may be a hardware component, a software component, or a combination of hardware and software. Some of the components may be application level software, while other components may be operating system level components. In some cases, the connection of one component to another may be a close connection where two or more components are operating on a single hardware platform. In other cases, the connections may be made over network connections spanning long distances. Each embodiment may use different hardware, software, and interconnection architectures to achieve the described functions.

Embodiment 100 is an example of an application that may use an annotated hierarchical data type definition to automatically generate user interfaces. The application may use other predefined user interfaces as building blocks on which to construct a customized user interface, and the predefined user interfaces may be selected based on the hierarchical data type definition.

In many applications, complex data types may be created to describe elements being manipulated. For example, an application may monitor various client computers, collect data from the client computers, create and manage help desk tickets, and issue work orders for technicians to execute. Such a system may have many different data types arranged in a hierarchical fashion.

In the example, a base class may be defined as a device. Several data types may be instances of the device class, and one of which may be a computer. For the computer data type, several types may be defined that inherit the properties of the computer type and the device class. One such type may be a server computer. From the server computer, several more data types may be defined for different types of operating systems, and from those data types, data types may be defined for different versions of the operating system.

In the example, a large number of data types may be defined, and each data type may contain one or more elements that are associated with the data type. Each element may be a parameter for which a value may or may not be defined.

The device 102 may represent a conventional computing device on which an application may execute. The device 102 may have hardware components 104 and software components 106 that may represent a conventional desktop or server computer. The device 102 may be any type of computing device, such as a desktop or server computer, game console, network appliance, or other similar device. In some embodiments, the device 102 may be a portable device, such as a laptop or netbook computer, personal digital assistant, mobile telephone, or other device. While not illustrated in embodiment 100, some embodiments may be deployed using cloud computing technologies that may or may not have a notion of a hardware platform on which an application may execute.

The hardware components 104 may include a processor 108, which may access random access memory 110 and nonvolatile memory 112. The hardware components 106 may include a network interface 114 and a user interface 116. The user interface 116 may include display devices 118 and input devices 120.

The software components 106 may include an operating system 112 on which an application 124 may execute. The application 124 may have an automated user interface generator 126 that may read an annotated hierarchical data type definition 128 and may generate user interface, such as a data collection user interface 136 or a data display user interface 138.

The annotated hierarchical data type definition 128 may include a hierarchical data type 130 that may include annotations 132 and description strings 134. In some embodiments, the entire data type definition 128 may be defined in a single file, such as an XML file. In other embodiments, portions of the data type definition 128 may be defined in separate files which may or may not use different formats and protocols.

The hierarchical data type 130 may define a set of data types in a hierarchical fashion. A hierarchical definition may allow properties of a higher class or data type to be inherited by lower data types.

When automatically generating a user interface, the hierarchy may be used in several different manners. In one manner, the hierarchy may allow elements in a graphical user interface to be grouped or segregated according to the hierarchy. Examples of such grouping may be shown in embodiments 500 and 600 presented later in this specification.

In another manner, the hierarchy may be used to locate a predefined user interface that may be used to build a customized user interface for a selected type for which a predefined user interface does not exist. The hierarchy may be traversed up or down from a given data type to identify a predefined user interface. From the predefined user interface, additional elements associated with the selected type may be presented in an automatically generated section of the user interface.

The automatic user interface generator may allow a set of data types to be extended. For example, an application may allow a user to add new parameters or elements to a given data type. The additional elements may not have been known or even considered when the application and its user interfaces were created, but the user interface generator 126 may generate an extension to an existing user interface and present those elements to a user.

The annotations 132 may include metadata about the various elements. When defined in some XML embodiments, the annotations 132 may be included as various tagged items associated with elements in a data type. The annotations 132 may include an element name, a descriptive name, a help prompt, default values, value ranges, value options, and many other metadata. In some embodiments, the text based items in an annotation may include multiple versions for different languages. Some such embodiments may include description strings 134 embedded in an XML document or in a separate file or database.

The user interface generator 126 may use all of the items in the annotated hierarchical data type definition 128 to create various user interfaces. In addition to structuring the user interface based on the hierarchy, the descriptive names, help prompts, and other such items may be used to annotate user interface components.

The user interface components may be text boxes, drop down lists, radio buttons, check boxes, and other components that may be placed on a user interface. Such components may be labeled using the descriptive names and other text based descriptors.

The user interface components may be selected based on the acceptable values defined in the type definition. For example, an element that has a text type may have a text box input component selected. In another example, a drop down list may be selected for types that have a predefined set of options. For a Boolean type, a radio button or checkbox may be selected.

In many embodiments, a set of predefined user interfaces 125 may be associated with the data type definition 128. The predefined user interfaces 125 may include graphical user interfaces that may be rich user interfaces that may include graphics, typography, and other design elements.

In some embodiments, a user interface generator 126 may identify graphical design elements from a predefined user interface and apply some or all of the graphical design elements to an automatically generated portion of a user interface.

The predefined user interfaces 125 may be defined in XML or some other language that may be received by the user interface generator 126 and used to generate an actual user interface.

The user interface generator 126 may generate data collection user interfaces 136 and data display user interfaces 138. A data collection user interface 136 may include user interface components that may receive input from a user to collect data. A data display user interface 138 may present one or more instances of a data type. A data display user interface 138 may or may not have a mechanism for collecting input from a user.

In some embodiments, the application 124 may be a standalone application that operates on the device 102 and generates user interfaces that may be displayed on the user interface display devices 118. In other embodiments, the application 124 may create user interfaces that may be displayed on a remote device using a browser or other remote access mechanism. When a browser is used, the user interfaces may be defined using Hyper Text Markup Language (HTML) or other similar technologies such that the user interface may be rendered on a browser. In another remote technology, the user interfaces may be presented on a remote device using remote presentation technologies, sometimes known as remote desktop or remote terminal technologies.

In one example of the application 124, the application 124 may monitor various client devices 146 that may be accessed over a network 144. The application 124 may be able to gather performance information about the clients 146 using an automated data collector 142 and store data about each client 146 in database 140.

In such an example embodiment, a data type definition may be created that may have many different data types that may represent different types of clients, different configurations of the clients, software and hardware aspects of the clients, and many other data types. Such an embodiment may also include a mechanism for creating and managing trouble tickets that may be received by a help desk, among other things. Such an example may be discussed in embodiments 400, 500, and 600 presented later in this specification.

In some embodiments, the annotated type definition 150 may be stored in a remote server 148 and may be referenced by an application 124 on the device 102. In such an embodiment, the application 124 may be a distributed application.

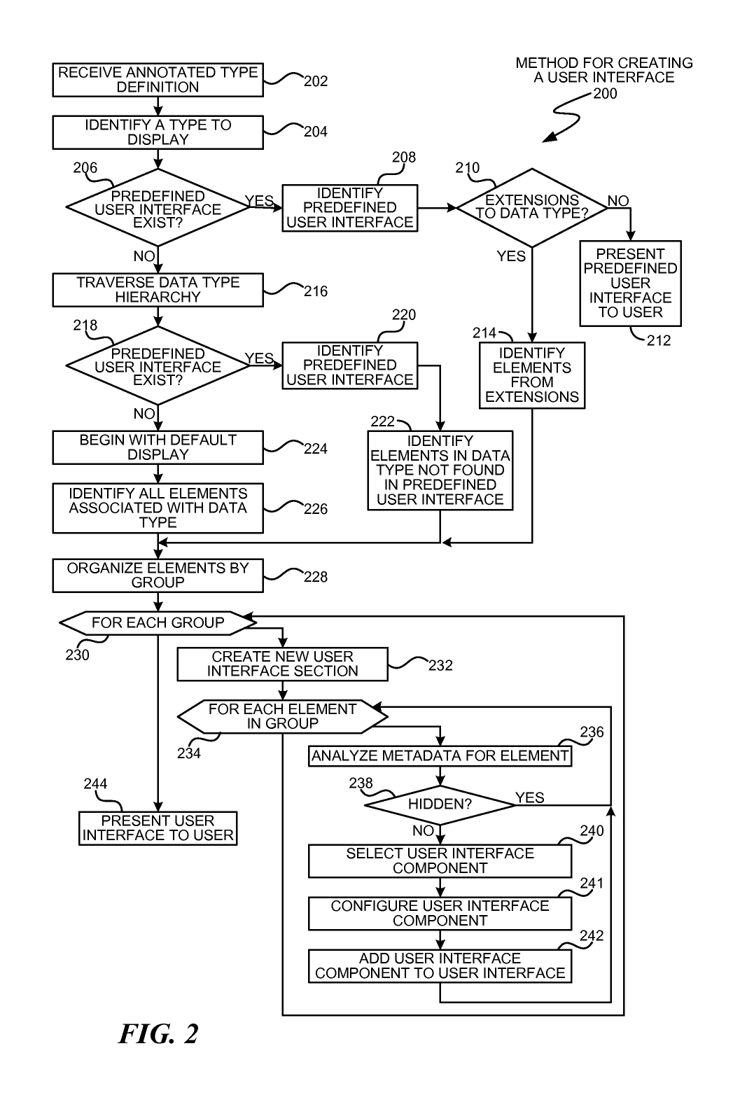

FIG. 2 is a flowchart illustration of an embodiment 200 showing a method for creating a user interface. Embodiment 200 is an example of a method that may be performed by an automated user interface generator, such as the user interface generator 126 of embodiment 100.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

Embodiment 200 illustrates one method for creating a user interface using a hierarchical data type definition. When a data type is selected that does not have a predefined user interface, a predefined user interface may be selected from the hierarchy of data types. The differences between the predefined user interface and the selected data type are identified, and the predefined user interface may be modified to include the different elements.

Embodiment 200 illustrates a method whereby an application may have many data types for which a user interface may be generated, but may contain fewer user interfaces that may be actually defined. The user interfaces that may be defined may be used as templates and may be expanded to include other elements.

An annotated type definition may be received in block 202. In many embodiments, the type definition may be a hierarchical type definition where lower level types may inherit properties from higher level types. Each type may have several elements that may be parameters associated with the type, as well as various metadata about the type and the elements associated with the type.

In many embodiments, an element may have metadata that may include identification metadata. Identification metadata may include an element name, short descriptor, long descriptor, help text, or other information that may be used to identify the element in a user interface. In some embodiments, such identification information may include a set of text strings in different languages. When a language is selected, those descriptors in the language may be displayed.

The metadata may include parameter or value metadata. The value metadata may define a data type for an element, which may be a primitive data type such as Boolean, integer, real number, string, or other data type. In some cases, the element data type may be a complex data type that may have a set of string values, for example, or other data type that may be constructed from the primitive data types.

The value metadata may include a range of values as well as default values for an element in some cases. The range of values may be used to configure a user interface component so that some initial value checking may be performed by the user interface.

A type may be identified in block 204 to display. The type may be a complex data type that may have multiple elements.

If a predefined user interface exists in block 206, the user interface may be selected in block 208. If there are no extensions to the data type in block 210, the predefined user interface may be presented to the user in block 212.

If there are extensions to the data type in block 210, a set of elements may be identified in block 214 from the extensions. The set of elements may be processed later in the method at block 228 to create additional user interface components.

If the predefined user interface does not exist in block 206, the data type hierarchy may be traversed in block 216 to attempt to identify a predefined user interface from another data type. The data type hierarchy may examine each data type between the selected data type and a base class in order and may select the first predefined user interface that may be detected.

In a hierarchical data type definition, the elements from each parent class and data type may be inherited by the lower level data types. In such an embodiment, a predefined user interface for a higher level data type may contain many of the elements for a lower level data type and may be used as a starting point for an automatically generated user interface for the lower level data type.

In other embodiments, the data type hierarchy may be traversed downwards to identify a predefined user interface. Such a predefined user interface may reference a child or grandchild data type from the selected data type, and may include more elements than may be found in the selected data type. In such an embodiment, the automatically generated user interface may have certain elements removed from the predefined user interface.

If a predefined user interface is found in block 218, the predefined user interface may be identified in block 220 and elements that are not found in the predefined user interface but are found in the selected data type may be identified in block 222. The identified elements may be those elements for which the predefined user interface may be modified to include. The process may continue in block 228.

If no predefined user interface is selected in block 218, a default user interface may be used in block 224. A default user interface may include default settings, such as language, color palette, font, font size, or other parameters. In some cases, a default user interface may include graphics and other design elements.

Because no predefined user interface is selected in block 218, all of the elements associated with a data type may be identified in block 226. The elements may include any elements that may be inherited from other data types or classes.

The selected elements in block 228 may be grouped or arranged. In some cases, the grouping may be defined by the hierarchy. In such cases, each data type or class from which a group of elements may be inherited may be used as a grouping. The grouping may assist in creating a user interface that may have elements gathered and arranged in meaningful or intuitive manners. Examples of grouped elements may be found in embodiments 400, 500, and 600 presented later in this specification.

For each group in block 230, a new user interface section may be created in block 232. The section may be a collapsible section, tabbed section, or have some graphical differentiator to separate the elements for the group.

In cases where a predefined user interface is used, design elements from the predefined user interface may be identified in the predefined user interface and applied to the newly created section. The design elements may include graphical images, color pallet, font, font size, layout, styles, and other elements.

For each element in the group in block 234, the metadata for the element may be analyzed in block 236. If the element is a hidden element in block 238, the process may return to block 234.

If the element is not hidden in block 238, a user interface component may be selected in block 240, configured in block 241, and added to the user interface in block 242. The user interface component may be a text box, radio button, check box, drop down list, or other object that may represent an element. The user interface component may be selected by matching a data type of the element with a corresponding user interface component.

In some embodiments, the metadata associated with an element may indicate which type of user interface component may be used for displaying the element. In embodiments where no such indication exists, a style definition for a predefined user interface or a default setting may determine a user interface component for an element.

The user interface component may be configured in block 241, which may consist of applying labels or descriptors to the user interface component. The descriptors may be selected to match a selected language for the user interface. In some embodiments, a user interface component may have a help feature that may have a detailed description of the element to assist a user. Such detailed description may be added to a user interface so that the use may view the detailed description on request.

The configuration of block 241 may also include defining limits for the values acceptable for the user interface component. When limits are included in a user interface component, the user interface may perform initial check of any value received from a user so that the value may be within a predefined set of values.

After processing each element in block 234, each group may be similarly processed in block 230. After all groups are processed in block 230, the user interface may be ready for presentation to a user in block 244.

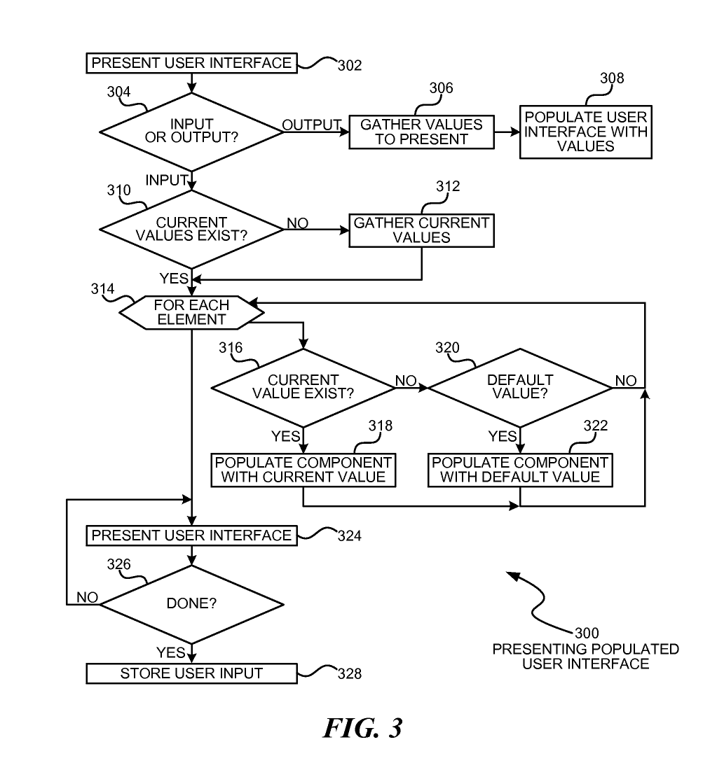

FIG. 3 is a flowchart illustration of an embodiment 300 showing a method for populating user interface. Embodiment 300 is an example of a method that may be performed by an automated user interface generator, such as the user interface generator 126 of embodiment 100, and may illustrate how a user interface may be populated with existing or default values.

Other embodiments may use different sequencing, additional or fewer steps, and different nomenclature or terminology to accomplish similar functions. In some embodiments, various operations or set of operations may be performed in parallel with other operations, either in a synchronous or asynchronous manner. The steps selected here were chosen to illustrate some principles of operations in a simplified form.

A user interface may be presented in block 302.

If the user interface is a display-type user interface meant to present information, such as the data display user interfaces 138 of embodiment 100, the values to present may be gathered in block 306 and used to populate the user interface with the values in block 308.

If the user interface is meant to gather information from a user in block 304, and current values exist for the current instance of the data type in block 310, those values may be gathered in block 312. If no current values exist in block 310, the process may skip to block 314.

For each element in block 314, if a current value exists in block 316, the user interface component for that element may be populated with that value in block 318. If a current value does not exist in block 316 and a default value for the element exists in block 320, the component may be populated with the default value in block 322. If no default value exists, the process may return to block 314.

Once all of the elements have their corresponding user interface components populated with existing or default values in blocks 314 through 322, the data collection user interface may be used to receive user input in block 324. The user may interact with the user interface in block 324 until the user is done in block 326. When the user is done in block 326, the user input may be stored in block 328.

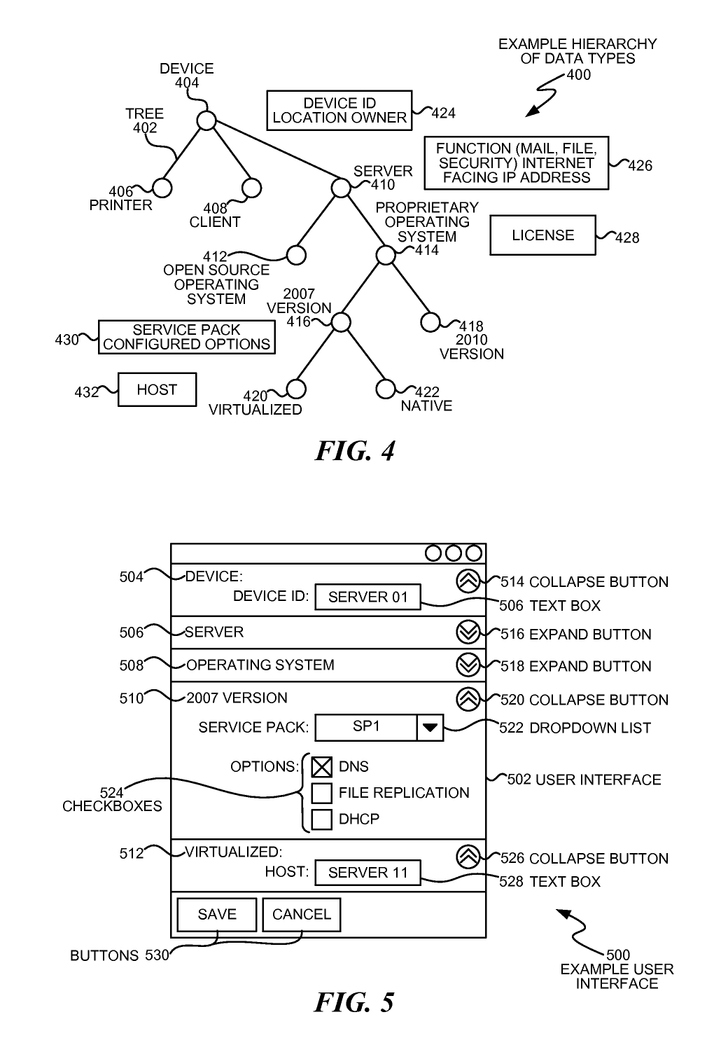

FIG. 4 is a diagram illustration of an embodiment 400 showing an example of a hierarchy of data types. The data types described in embodiment 400 are illustrated as user interfaces in embodiments 500 and 600.

The examples of embodiments 400, 500, and 600 are merely one example of a hierarchical data type definition may be used to generate user interfaces.

Embodiment 400 shows a tree 402 that may represent a hierarchy of data types associated with computers and other devices. The top level class may be a device 404. Children of the device 404 may be a printer 406, a client 408, and a server 410. Children of the server 410 may be open source operating system 412 and proprietary operating system 414.

The proprietary operating system 414 may have children data types of a 2007 version 416 and a 2010 version 418. The 2007 version 416 may have children data types of virtualized 420 and native 422.

The tree 402 may show a hierarchical set of data types where elements associated with each data type may be inherited by child data types.

The device 404 is illustrated as having elements 424, which may consist of “device ID”, “location”, and “owner”. These elements may be common to all child data types from the device 404.

The server 410 is illustration as having elements 426, which may consist of “function”, “Internet facing”, and “IP address”. The proprietary operating system 414 may have a single element 428 “license”. The 2007 version 416 may have elements 420 that consist of “service pack” and “configured options”. Lastly, the virtualized 420 data type may have element 432 “host”.

FIG. 5 is a diagram illustration of an embodiment 500 showing an example user interface that may be created from the hierarchical data type of embodiment 400. Embodiment 500 illustrates a graphical user interface that may be created to collect data for the data type virtualized 420 of embodiment 400.

The user interface 502 of embodiment 500 illustrates one form of a grouped user interface. In the case of embodiment 500, the elements of each data type may be presented in sections of the user interface that may be collapsed and expanded.

The user interface 502 illustrates several groups that correspond to data types, such as the device 504, server 506, operating system 508, 2007 version 510, and virtualized 512. The groups for the device 504, 2007 version 510, and virtualized 512 are illustrated as expanded, while the other groups are illustrated as collapsed. The collapse buttons 514, 520, and 526 may be activated by a user to collapse the respective group. Similarly, the expand buttons 516 and 518 may be used to expand the respective group.

The device 504 group contains a single text box 506 that corresponds to a device ID element. In the elements 424 of embodiment 400, three elements may be defined for the device 404, but only one of the elements may be displayed in the group of device 504. This may be because the other elements may be defined as hidden and therefore not displayed.

In the 2007 version 510 group, a drop down list 522 may be created to represent the element “service pack” and several checkboxes 524 may represent the “configured options” element 430. Similarly, the virtualized 512 group may contain a text box 528 for the element “host”.

The user interface 502 may include buttons 530 to allow the user to either save their changes or to cancel the operation.

The user interface 502 is illustrated as being populated with some data. Each of the text boxes 506 and 528 are displaying a value, as is the drop down list 522 and the checkboxes 524.

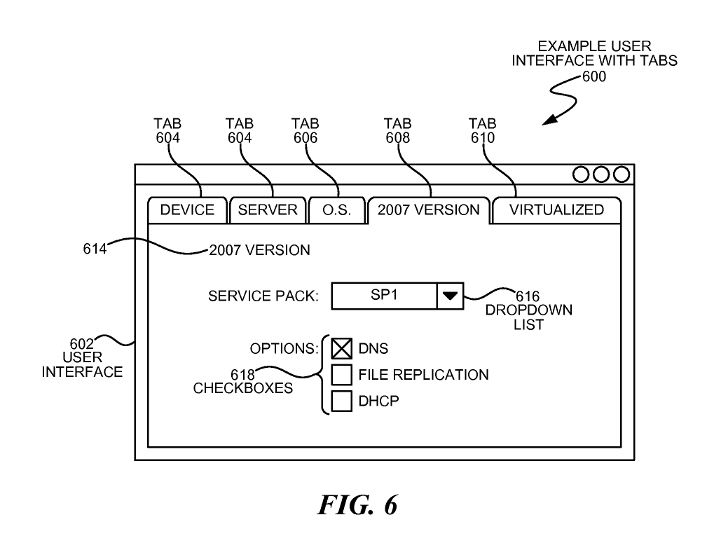

FIG. 6 is a diagram illustration of an embodiment 600 showing an example user interface that may be create from the hierarchical data type of embodiment 400. Embodiment 600 illustrates a second graphical user interface that may be created to collect data for the data type virtualized 420 of embodiment 400.

The user interface 602 of embodiment 600 illustrates a second form of a grouped user interface. In the case of embodiment 600, the elements of each data type may be presented as tabbed portions of the user interface 602. A user may select between each tab to display elements associated with the group and interact with the user interface controls for those elements.

Each tab 604, 606, 608, 610, and 612 may represent one of the data types of device 404, server 410, proprietary operating system 412, 2007 version 414, and virtualized 420, respectively. Tab 601 is illustrated as selected and the user interface components representing elements corresponding with the 2007 version 614 are shown.

A drop down list 616 may represent the “service pack” element 430, and the checkboxes 618 may represent the “configured options” element 430.

Embodiments 500 and 600 illustrate two types of user interfaces that may be created using an automated user interface generator. In the case of embodiment 500, a predefined user interface may be created for the 2007 version data type and the elements of the virtualized data type may be added to the existing user interface by merely adding another group section and the user interface controls corresponding to the elements of that data type.

Similarly, embodiment 600 may illustrate an embodiment where each tab may represent a single data type. When one or more of the data types may not have a predefined user interface, an automated user interface generator may create a new tab representing the data type and add appropriate user interface components. In this manner, an existing user interface may be easily expanded to include additional data types and additional elements for a given data type.

The foregoing description of the subject matter has been presented for purposes of illustration and description. It is not intended to be exhaustive or to limit the subject matter to the precise form disclosed, and other modifications and variations may be possible in light of the above teachings. The embodiment was chosen and described in order to best explain the principles of the invention and its practical application to thereby enable others skilled in the art to best utilize the invention in various embodiments and various modifications as are suited to the particular use contemplated. It is intended that the appended claims be construed to include other alternative embodiments except insofar as limited by the prior art.

What is claimed is:

1. A method performed on a computer processor, said method comprising:
receiving an annotated type definition, said annotated type definition comprising a hierarchy of types and metadata about said types;
identifying a first type for which to create a first user interface;
determining that a predefined user interface does not exist for said first type;
identifying a set of related types for said first type, said related types comprising a base class;
examining said set of related types to identify a first predefined user interface for a second type, said second type being related to said first type;
identifying a set of elements contained in said first type and not a member of said second type;
creating a set of user interface components based on said set of elements; and
presenting a new user interface comprising said first predefined user interface and said set of user interface components.

2. The method of claim 1 further comprising:
populating said set of user interface components with descriptors, said descriptors being contained in said annotated type definition.

3. The method of claim 2 further comprising:
determining a display language for said new user interface; and
selecting said descriptors based on said display language.

4. The method of claim 3 further comprising: presenting said set of user interface components in a grouped fashion.

5. The method of claim 4, said grouped fashion comprising creating a section in said new user interface comprising at least a portion of said set of user interface components.

6. The method of claim 5, said section comprising a tabbed display.

7. The method of claim 5, said section comprising a collapsible display.

8. The method of claim 1 further comprising:
populating at least one of said user interface components with a default value.

9. The method of claim 1 further comprising:
determining a current value for a first element, said first element being one of said set of elements; and
populating a first user interface component with said current value, said first user interface component representing said first element.

10. The method of claim 1 further comprising:
identifying a plurality of options for a first element; and
populating a first user interface component with said plurality of options.

11. The method of claim 1 further comprising:
determining that a first element is a hidden element; and
not displaying a first user interface component related to said first element.

12. A system comprising:
a processor;
a user interface display;
an application operable on said processor, said application comprising:
an annotated type definition, said annotated type definition comprising a hierarchy of types and metadata about said types;
a user interface generator that:
identifies a first type for which to create a first user interface;
determines that a first predefined user interface does not exist for said first type;
identifies a set of related types for said first type, said related types comprising a base class;
examines said set of related types to identify a second predefined user interface for a second type, said second type being related to said first type;
identifies a set of elements contained in said first type and not a member of said second type;
creates a set of user interface components based on said set of elements; and
presents a new user interface comprising said second predefined user interface and said set of user interface components on said user interface display.

13. The system of claim 12, said annotated type definition further comprising a descriptor a first element.

14. The system of claim 13, said annotated type definition further comprising a default value for said first element.

15. The system of claim 14, said annotated type definition further comprising a hidden modifier for said first element, said user interface generator that further does not display a user interface component related to said first element.

16. The system of claim 15, said annotated type definition comprising a plurality of groupings for said elements, said user interface generator that further arranges said set of user interface components according to said groupings.

17. The system of claim 16, said grouping being defined at least in part by said hierarchy of types.

18. A method performed on a computer processor, said method comprising:
receiving an annotated type definition, said annotated type definition comprising a hierarchy of types and metadata about said types, said metadata comprising descriptors for said types, a first default value for a first element associated with a first type;
identifying said first type for which to create a first user interface;
determining that a predefined user interface does not exist for said first type;
identifying a set of related types for said first type, said related types comprising a base class and a second type, said second type being in said hierarchy between said base class and said first type;
examining said set of related types to identify a first predefined user interface for said second type;
identifying a set of elements contained in said first type and not a member of said second type;
creating a set of user interface components based on said set of elements; and
presenting a new user interface comprising said first predefined user interface and said set of user interface components.

19. The method of claim 18 further comprising:
identifying said second type for which to create a second user interface;
determining that said first user interface is a predefined user interface for said second type; and
presenting said first user interface.

20. The method of claim 19 further comprising:
identifying a current set of values for said first type; and
populating said new user interface with said current set of values.
